(19) United States
(12) Patent Application Publication
(10) Pub. No.: US 2003/0036428 A1
(43) Pub. Date: Feb. 20, 2003

(54) Method and apparatus for implementing multiplayer PDA games

(76) Inventor: Christian Aasland, Rochester, MN (US)

Correspondence Address: Grant A. Johnson, IBM Corporation - Dept. 917, 3605 Highway 52 North, Rochester, MN, 55901, US

(21) Appl. No.: 09/933,368

(22) Filed: Aug. 20, 2001

(51) Int. Cl. A63F 13/00

(52) U.S. Cl. 463/29

(57) ABSTRACT

A method, apparatus and computer program product are provided for implementing multiplayer Personal Data Assistant (PDA) games. Apparatus for implementing multiplayer PDA games includes a plurality of PDA units. Each PDA unit has capability for determining geographic location of the PDA unit, such as Global Positioning System (GPS) capability. Each PDA unit is adapted for receiving player selected actions. A game server communicates with the plurality of PDA units via a wireless communications link. The game server identifies the geographic location of the PDA units and selectively enabling games rules based upon the geographic location of respective PDA units. Each of the plurality of PDA units includes a communications adapter enabling communications of the plurality of PDA units with the Internet. The game server can be implemented with a selected one of the PDA units or a predetermined computer.

### FIELD OF THE INVENTION

The present invention relates generally to the data processing field, and more particularly, relates to a method, apparatus and computer program product for implementing multiplayer Personal Data Assistant (PDA) games.

### DESCRIPTION OF THE RELATED ART

Various computer games are known in the art. Multiplayer interactive video gaming machines are known that employ a network arrangement. A number of multiplayer computer games have appeared on the Internet.

In order to improve realism of many computer games, there is great interest in the development of computer systems which enable users to quickly generate displays with better graphic displays and that include new control devices, and the like. Significant development efforts generally are to provide computer systems with advanced graphic display systems providing dynamic resolution capabilities as well as a high quality reproduction display. In general, known development efforts have been directed to providing an improved computer generated reality for the computer game.

A portable data processing device, referred to as a personal digital assistant (PDA) provides various productivity applications, such as a calendar and an address book, in a convenient, hand held form factor. Wireless personal data assistants (PDAS) are known, such as the Palm Pilot manufactured by 3Com Corporation.

A need exists for an improved method, apparatus and computer program product for implementing multiplayer Personal Data Assistant (PDA) games.

### SUMMARY OF THE INVENTION

A principal object of the present invention is to provide a method, apparatus and computer program product for implementing multiplayer Personal Data Assistant (PDA) games. Other important objects of the present invention are to provide such method, apparatus and computer program product for implementing multiplayer Personal Data Assistant (PDA) games that efficiently and effectively facilitates interactive play based upon player environments; to provide such method, apparatus and computer program product for implementing multiplayer Personal Data Assistant (PDA) games substantially without negative effect; and that overcome some disadvantages of prior art arrangements.

In brief, a method, apparatus and computer program product are provided for implementing multiplayer Personal Data Assistant (PDA) games. Apparatus for implementing multiplayer PDA games includes a plurality of PDA units. Each PDA unit has capability for determining geographic location of the PDA unit. Each PDA unit is adapted for receiving player selected actions. A game server communicates with the plurality of PDA units via a wireless communications link. The game server identifies the geographic location of the PDA units and selectively enabling games rules based upon the geographic location of respective PDA units.

In accordance with features of the invention, each of the plurality of PDA units includes a communications adapter enabling communications of the plurality of PDA units with the Internet and Global Positioning System (GPS) capability. The game server can be implemented with a selected one of the PDA units or a predetermined computer.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a computer system for implementing multiplayer Personal Data Assistant (PDA) games in accordance with the preferred embodiment;

FIG. 2 is a block diagram representation illustrating a Personal Data Assistant/Global Positioning System (PDA/GPS) unit of the computer system of FIG. 1 for implementing multiplayer games in accordance with the preferred embodiment;

FIG. 3 is a flow chart illustrating exemplary sequential steps for implementing multiplayer Personal Data Assistant (PDA) games in accordance with the preferred embodiment; and

FIG. 4 is a block diagram illustrating a computer program product in accordance with the preferred embodiment.

### DETAILED DESCRIPTION OF THE PREFERRED EMBODIMENTS

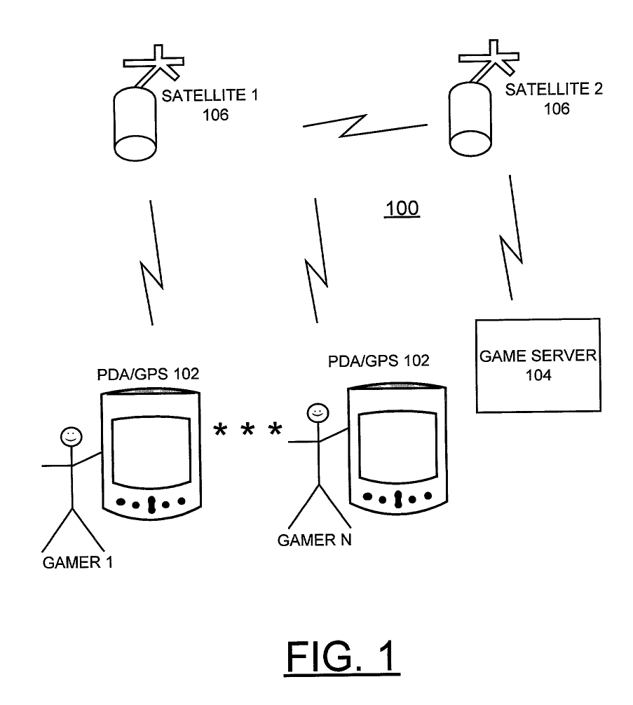

Having reference now to the drawings, in FIG. 1, there is shown a computer system of the preferred embodiment generally designated by the reference character 100. Computer system 100 of the preferred embodiment is a wireless communication system for implementing interactive, multiplayer Personal Data Assistant (PDA) games. Computer system 100 includes a plurality of Personal Data Assistant/Global Positioning System (PDA/GPS) units 102, a game server 104, and a plurality of satellites 106. Each of multiple game players 1-N uses a respective PDA/GPS unit 1-N, 102 for participating in multiplayer Personal Data Assistant (PDA) games of the preferred embodiment. PDA/GPS units 102 are wireless units adapted for communicating with the game server 104 and directly with other PDA/GPS units 102. PDA/GPS units 102 include wireless peer-to-peer communications capability, for example, using the Bluetooth or 802.11 communication standards. PDA/GPS units 102 include the capability to communicate with the Internet. The multiple satellites 106 enable operation of the Global Positioning System (GPS) capability of each PDA/GPS unit 102 and other communications between the PDA/GPS units 102 and game server 104.

In accordance with features of the preferred embodiment, the GPS capabilities of the PDA/GPS units 102 enable the determination of a geographic location of the respective multiple game players 1-N. Game server 104 can identify the geographic location of each game player by querying the PDA/GPS units 102. Using the geographic location of each game player enables the use of games rules based upon the player environments or the players' reality. Rather than attempting to improve realism of computer games by providing an improved computer generated reality for the computer games, the interactive, multiplayer Personal Data Assistant (PDA) games of the preferred embodiment utilize the players' reality to define an interactive, multiplayer game.

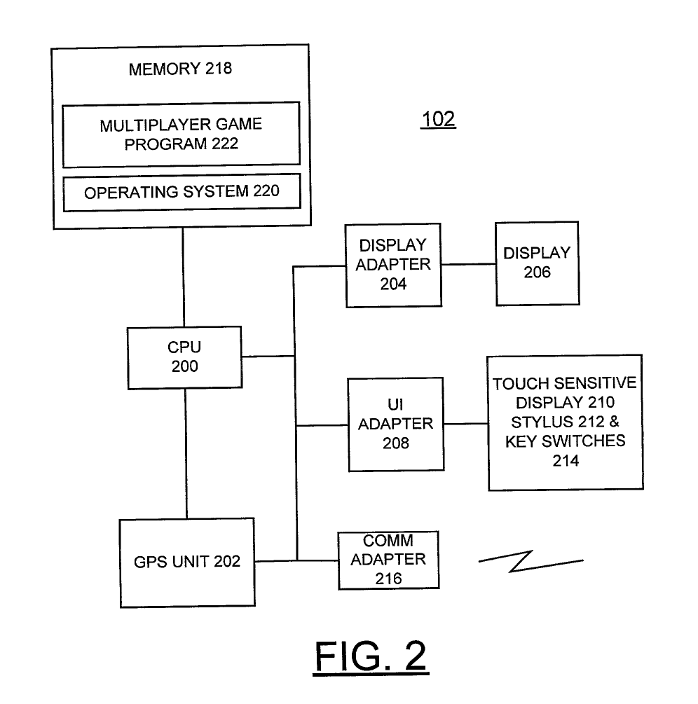

Referring now to FIG. 2, there is shown the PDA/GPS 102 for implementing multiplayer games in accordance with the preferred embodiment. In FIG. 2, PDA/GPS 102 is shown in simplified form sufficient for an understanding of the present invention. As shown in FIG. 2, PDA/GPS 102 includes a central processor unit (CPU) 200 coupled to a GPS unit 202. CPU 200 is connected to a display adapter 204 coupled to a display 206. CPU 200 is connected to a user interface (UI) adapter 208 connected to user entry devices, such as a touch sensitive display 210 and a stylus 212 and key switches 214 for providing user selections. CPU 200 is connected to a communications adapter 216 providing multiple communications functions within satellite communication computer game system 100. Each PDA/GPS 102 includes the capability to communicate via communications adapter 216 with the Internet, for example, for receiving e-mail and downloading games and game rules. PDA/GPS 102 includes a memory 218 storing an operating system 220 and a multiplayer game program 222 of the preferred embodiment.

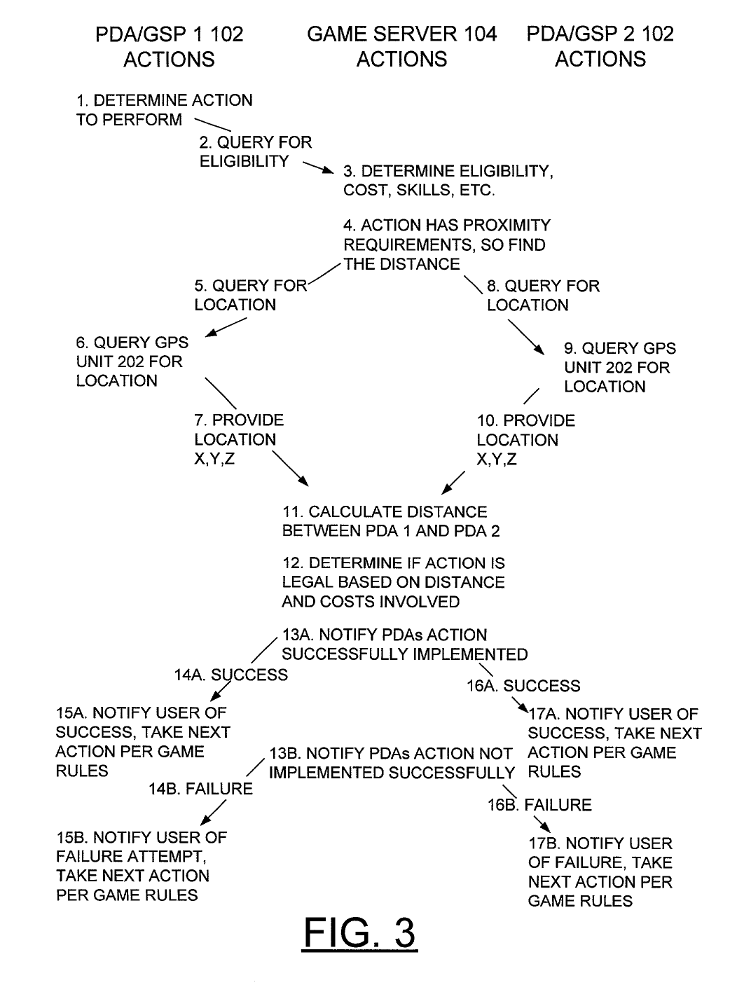

PDA/GPS 102 may be implemented using any suitable Personal Data Assistant (PDA) including capability for determining geographic location of the PDA, such as GPS capabilities of a conventional GPS unit 202. Central processor unit 200 is suitably programmed to execute the flow chart of FIG. 3 of the preferred embodiment. Game server computer 104 may be implemented using any suitable computer, such as an IBM personal computer running the OS/2® operating system. Game server computer 104 may be implemented using any suitable Personal Data Assistant (PDA) unit.

Referring now to FIG. 3, there are show exemplary sequential steps or actions performed by first and second PDA/GPS 102 and game server 104 of the satellite communication computer game system 100. It should be understood that the multiplayer PDA games of the preferred embodiment include peer-to-peer multiplayer PDA games, and game server 104 is implemented by one of the PDA/GPS 102.

At step 1, the first PDA/GPS 102 determines an action to perform, for example, responsive to a player's input selection. First PDA/GPS 102 sends a query for eligibility to the game server 104 at step 2. Game server 104 determines eligibility, identifying cost, skills and the like for the step 1 action as indicated at step 3. Game server 104 identifies proximity requirements for the step 1 action, so game server 104 makes a determination to find the distance as indicated at step 4.

At step 5, game server 104 sends a query for location to the first PDA/GPS 102. Responsive to the location query from game server 104, first PDA/GPS 102 queries its GPS unit 202 for location as indicated at step 6. First PDA/GPS 102 sends its location information (x, y, z) to the game server 104 as indicated at step 7. At step 8, game server 104 sends a query for location to the second PDA/GPS 102. Responsive to the location query from game server 104, second PDA/GPS 102 queries its GPS unit 202 for location as indicated at step 9. Second PDA/GPS 102 sends its location information (x, y, z) to the game server 104 as indicated at step 10.

Game server 104 calculates the distance between the first PDAIGPS 102 and the second PDA/GPS 102 as indicated at step 11. Next game serve 104 determines if the action is legal based upon the distance between the first PDA/GPS 102 and the second PDA/GPS 102 and the costs involved as indicated at step 12. Game server 104 notifies the first PDA/GPS 102 and the second PDA/GPS 102 that the action has been successfully implemented if determined that the action is legal as indicated at step 13A. At step 14A, game server 104 sends a success notification to the first PDA/GPS 102 responsive to determination that the action is legal. The first PDA/GPS 102 notifies the user of success as indicated at step 15A. At step 16A, game server 104 sends a success notification to the second PDA/GPS 102 responsive to determination that the action is legal. The second PDA/GPS 102 notifies the user of success as indicated at step 17A.

Otherwise, game server 104 notifies the first PDA/GPS 102 and the second PDA/GPS 102 that the action has not been implemented successfully if determined that the action is not legal as indicated at step 13B. At step 14B, game server 104 sends a failure notification to the first PDA/GPS 102 responsive to determination that the action is not legal. The first PDA/GPS 102 notifies the user of failure as indicated at step 15B. At step 16B, game server 104 sends a failure notification to the second PDA/GPS 102 responsive to determination that the action is not legal. The second PDA/GPS 102 notifies the user of failure as indicated at step 17B.

In accordance with features of the preferred embodiment, the GPS capabilities of the PDA/GPS units 102 enable enhanced interactive, multiplayer games that can be played in defined geographic areas, such as local, campus, or metropolitan areas, rather than just a virtual format. Game rules that are selectively implemented based upon the geographic locations of the players allows for various multiplayer interactions and more interesting multiplayer games.

For example, a form of the game know as “Capture the Flag” can be played in local, campus, or metropolitan areas in accordance with multiplayer Personal Data Assistant (PDA) games of the preferred embodiment, rather than just a virtual format. Each player uses the PDA/GPS units 102 with the GPS capabilities and game server 104 tracks the virtual position of the flags and the player geographic locations. When the game server 104 determines that a player is at the location of the flag, the server 104 tracks that the player has picked up the flag, and continues to track the flag location with the player's PDA/GPS units 102.

A form of massively multiplayer online games, such as the well-known “Everquest” game, advantageously can be implemented on a more personal player level in accordance with multiplayer Personal Data Assistant (PDA) games of the preferred embodiment. Everquest includes concepts of magic and spells that can be cast. With each player using the PDA/GPS units 102 with the GPS capabilities, a particular player can cast a spell on oneself, another player or a group of players. The game server 104 determines if the player has the ability to cast such a spell and whether each targeted opponent is within a set range that is determined using GPS identified locations of PDA/GPS units 102 of these players. The PDA/GPS units 102 of the targeted opponents are then affected by that spell.

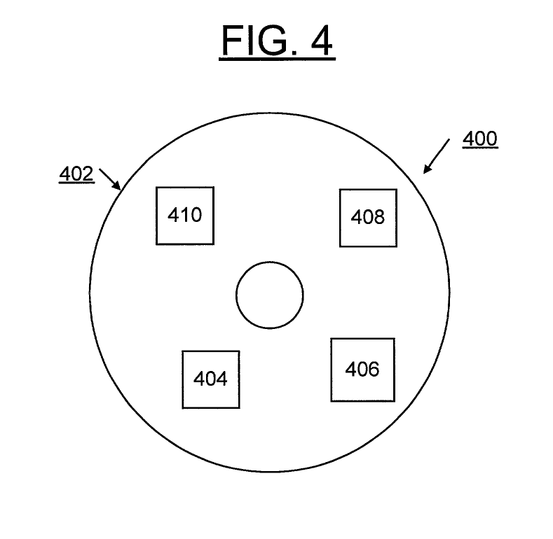

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for implementing interactive, multiplayer Personal Data Assistant (PDA) games of the preferred embodiment in the system 100 of FIG. 1.

A sequence of program instructions or a logical assembly of one or more interrelated modules defined by the recorded program means 404, 406, 408, 410, direct the satellite communication computer game system 100 for implementing multiplayer Personal Data Assistant (PDA) games of the preferred embodiment.

While the present invention has been described with reference to the details of the embodiments of the invention shown in the drawing, these details are not intended to limit the scope of the invention as claimed in the appended claims.

What is claimed is:

1. Apparatus for implementing multiplayer Personal Data Assistant (PDA) games comprising:
a plurality of PDA units, each PDA unit having capability for determining geographic location of said PDA; each PDA unit for receiving player selected actions; and
a game server communicating with said plurality of PDA units via a wireless communications link; said game server identifying said geographic location of said PDA units and selectively enabling games rules based upon the geographic location of respective PDA units.

2. Apparatus for implementing multiplayer Personal Data Assistant (PDA) games as recited in claim 1 wherein each PDA unit includes a Global Positioning System (GPS) unit and further comprising a plurality of satellites enabling operation of said Global Positioning System (GPS) capability of each said PDA unit.

3. Apparatus for implementing multiplayer Personal Data Assistant (PDA) games as recited in claim 1 wherein each of said plurality of PDA units includes a communications adapter enabling communications of said plurality of PDA units with the Internet.

4. Apparatus for implementing multiplayer Personal Data Assistant (PDA) games as recited in claim 1 wherein each of said plurality of PDA units includes a memory storing a multiplayer game program.

5. Apparatus for implementing multiplayer Personal Data Assistant (PDA) games as recited in claim 1 wherein each of said plurality of PDA units includes user entry devices for receiving said player selected actions.

6. Apparatus for implementing multiplayer Personal Data Assistant (PDA) games as recited in claim 1 wherein each of said plurality of PDA units includes a display for notifying player game actions.

7. Apparatus for implementing multiplayer Personal Data Assistant (PDA) games as recited in claim 1 wherein said game server comprises a selected one of said PDA units or a predetermined computer.

8. A method for implementing multiplayer, interactive Personal Data Assistant (PDA) games in a computer game system including a plurality of PDA units, each PDA unit having capability for determining geographic location of the PDA, said method comprising the steps of:
receiving a player selected action;
identifying a geographic location of respective ones of said plurality of PDA units, responsive to said player selected action; and
selectively enabling games rules based upon said geographic location of said respective PDA units.

9. A method for implementing multiplayer, interactive Personal Data Assistant (PDA) games as recited in claim 8 includes the step of determining a distance between said respective ones of said plurality of PDA units including a PDA unit receiving said selected action.

10. A method for implementing multiplayer, interactive Personal Data Assistant (PDA) games as recited in claim 9 includes the steps of notifying said respective ones of said plurality of PDA units of a successfully implemented selected action responsive to said distance being within a predefined range.

10. A method for implementing multiplayer, interactive Personal Data Assistant (PDA) games as recited in claim 9 includes the steps of notifying said respective ones of said plurality of PDA units of a failed selected action responsive to said distance being outside a predefined range.

11. A method for implementing multiplayer, interactive Personal Data Assistant (PDA) games as recited in claim 8 includes the step of querying a game server for eligibility of said player selected action; wherein said game server includes a selected one of said PDA units or a predetermined computer.

13. A method for implementing multiplayer, interactive Personal Data Assistant (PDA) games as recited in claim 12 wherein the step of identifying said geographic location of respective ones of said plurality of PDA units, responsive to said player selected action includes the steps of utilizing said game server for querying for location each of said respective ones of said plurality of PDA units; for receiving a location response from each of said respective ones of said plurality of PDA units; and for calculating a distance between said respective ones of said plurality of PDA units.

14. A method for implementing multiplayer, interactive Personal Data Assistant (PDA) games as recited in claim 13 includes the steps of utilizing said game server for notifying respective ones of said plurality of PDA units of a successfully implemented selected action responsive to said calculated distance being within a predefined range.

15. A method for implementing multiplayer, interactive Personal Data Assistant (PDA) games as recited in claim 13 includes the steps of utilizing said game server for notifying respective ones of said plurality of PDA units of a failed selected action responsive to said calculated distance being outside a predefined range.

16. A method for implementing multiplayer, interactive Personal Data Assistant (PDA) games as recited in claim 13 includes the steps of utilizing respective ones of said plurality of PDA units for notifying respective players of game actions.

17. A computer program product for implementing multiplayer, interactive Personal Data Assistant (PDA) games in a computer game system including a plurality of PDA units, each PDA unit having capability for determining geographic location of the PDA, said computer program product including a plurality of computer executable instructions stored on a computer readable medium, wherein said instructions, when executed by the PDA unit, cause the PDA unit to perform the steps of:
receiving a player selected action;
querying a game server for eligibility of said player selected action;
identifying a geographic location of said PDA unit responsive to receiving a query from said game server by each of respective ones of said plurality of PDA units; and
selectively enabling games rules based upon said geographic location of said respective PDA units.

18. A computer program product for implementing multiplayer, interactive Personal Data Assistant (PDA) games as recited in claim 17 wherein said instructions, when executed by the PDA unit, further cause the PDA unit to perform the steps of notifying said game server of said identified geographic location of said PDA unit.

19. A computer program product for implementing multiplayer, interactive Personal Data Assistant (PDA) games as recited in claim 17 wherein said step of selectively enabling games rules based upon said geographic location of said respective PDA units includes the steps of receiving a notification from said game server and taking a next game action responsive to said received notification.

20. A computer program product for implementing multiplayer, interactive Personal Data Assistant (PDA) games as recited in claim 17 wherein said step of querying a game server for eligibility of said player selected action includes the steps of querying a selected one of said plurality of PDA units for eligibility of said player selected action and includes the step of communicating game information from one PDA unit of said plurality of PDA units to a second PDA unit of said plurality of PDA units via wireless peer-to peer communications.
